(19) United States
(12) Patent Application Publication
(10) Pub. No.: US 2007/0083476 A1
(43) Pub. Date: Apr. 12, 2007

(54) Method and system for enforcing user rights and maintaining consistency of user data in a data network

(75) Inventors: Sylvie Gomes, Douglaston, NY (US); AkinLolu Oloruntosi Kumoluyi, Marietta, GA (US); Alan Gerald Carlton, Mineola, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/507,636

(22) Filed: Aug. 21, 2006

Related U.S. Application Data
(60) Provisional application No. 60/725,497, filed on Oct. 11, 2005.

(51) Int. Cl. G06Q 99/00

(52) U.S. Cl. 705/59

(57) ABSTRACT

A method and system for enforcing user rights on user data, and maintaining consistency of the user data in a data network are disclosed. Each of a plurality of entities controls one or more network devices which are connected via the data network. Each network device includes at least one user data node which contains at least one elementary piece of user data. The elementary piece of user data is associated with a traceability graph including at least one traceability link. The traceability link connects a source user data node and a destination user data node. The user data node also contains rights information which comprises a rule-based policy regarding the user data. The rights information is also propagated to other entities based on the traceability graph. Consistency of the user data is achieved and owner's rights are enforced based on the traceability graph.

### CROSS REFERENCE TO RELATED APPLICATION

This application claims the benefit of U.S. Provisional Application No. 60/725,497 filed Oct. 11, 2005, which is incorporated by reference as if fully set forth.

### FIELD OF INVENTION

The present invention is related to a data network. More particularly, the present invention is related to a method and system for enforcing user rights on user data, and maintaining consistency of the user data in the data network.

### BACKGROUND

Conventional digital rights management (DRM) systems only protect static contents such as works of authorship. Enterprise DRM systems protect information from unauthorized access, but do not address the issue of the consistency across multiple copies of the same information. For example, an enterprise DRM system encrypts the data sent via email, such that only the authenticated recipient can access the information. The rights within the license remain with the information, and may grant multiple types of rights, (e.g., read, write and extract the content of the email). However, the forwarded information might be updated without being synchronized and two different versions of the information may exist.

One of the disadvantages of the conventional DRM systems is that they mostly focus on the encryption of the information for preventing unauthorized access. Even if this aspect is important to the security of the data, it does not solve the problem of the safe and automatic propagation of the information and the rights in a recursive manner from any legal entity to any other legal entities.

### SUMMARY

The present invention is related to a method and system for enforcing user rights on user data, and maintaining consistency of the user data in a data network. Each of a plurality of entities controls one or more network devices which are connected via the data network. Each network device includes at least one user data node which contains at least one elementary piece of user data. The elementary piece of user data is associated with a traceability graph including at least one traceability link. The traceability link connects a source user data node to a destination user data node. The user data node also contains rights information which comprises a rule-based policy regarding the user data. The rights information is also propagated to other entities based on the traceability graph. Consistency of the user data is achieved and an owner's rights are enforced based on the traceability graph.

### BRIEF DESCRIPTION OF THE DRAWINGS

FIG. 1 shows an exemplary system which supports user data traceability in accordance with the present invention.

FIG. 2 shows a specific example of a system which supports user data traceability in accordance with one embodiment of the present invention.

FIG. 3 shows a specific example of a system which supports user data traceability in accordance with another embodiment of the present invention.

FIG. 4 shows a block diagram of a system implemented by service oriented architecture (SOA) in accordance with the present invention.

FIG. 5 is a block diagram of a rights and consistency enforcement service (RCES) running in the network devices of FIG. 4.

### DETAILED DESCRIPTION OF THE PREFERRED EMBODIMENTS

When referred to hereinafter, the terminology “entity” refers to a “person” (real or moral), as seen under the law of relevant jurisdiction. An entity may own property, including intellectual property, may sue other entities or be sued by other entities, and has rights and duties under the law.

The features of the present invention may be incorporated into an integrated circuit (IC) or be configured in a circuit comprising a multitude of interconnecting components.

In reality, multiple copies of the same piece of information, (i.e., user data), exist across the network. In accordance with the present invention, consistency of multiple copies of the same piece of information across the network is guaranteed. In other words, all the copies accurately reflect the changes made to the information contents by its “official” source and the rights of the owner of the information are guaranteed in a robust and cost effective way.

The owner of the user data controls and monitors distribution of the user data. For example, the owner of the user data may give the right to another entity to duplicate the user data, but not to distribute it to other entities. The owner may also give the right to the other entity to distribute the user data to other entities, but with the condition that the owner should be notified each time that duplication occurs. The owner of the user data may also give complete recursive rights to other entities regarding the distribution of the rights, (i.e., the other entities are allowed to distribute the user data with recursive rights to the entities they communicate with).

The user data is exchanged at the level of granularity of an elementary piece of user data. The elementary piece of user data is the smallest amount of user data that is considered as self-contained from a dynamic perspective. The contents of the elementary piece of user data may be updated independently of other elementary pieces of user data. The updated user data is automatically propagated in conformance with the owner's will which is expressed as rights information. This is achieved by maintaining traceability between the original user data and the duplicated user data. In addition, the rights information itself may be recursively propagated in the same way as the actual user data is propagated to reduce the complexity of managing the user rights in a large data network. In this way the owner of the user data may control and monitor the propagation of the user data in a cost effective way.

In accordance with the present invention, technical and legal concerns are separated. This separation enables two distinct topologies: 1) a technical topology comprising a data network which connects a plurality of network devices; and 2) a legal topology comprising a user data traceability graph which connects user data nodes containing copies of the same piece of user data to address legal aspects and rights. The separation also enables distinction between a technical control and a legal control over the user data.

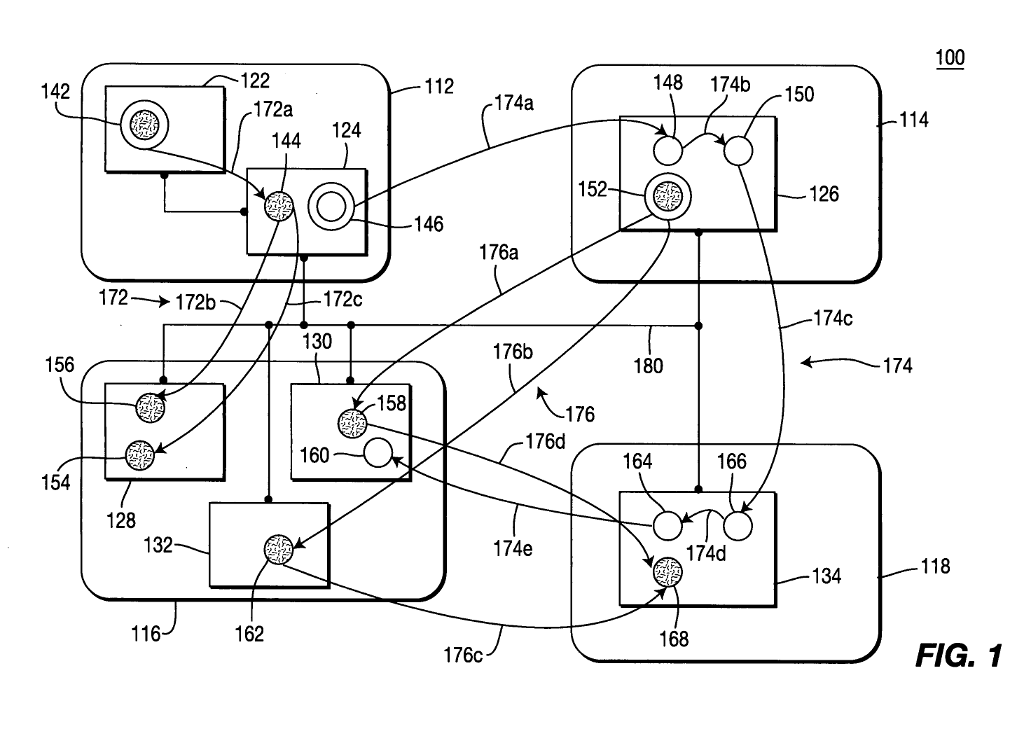

FIG. 1 is a block diagram of an exemplary system 100 which supports user data traceability in accordance with the present invention. The system 100 includes a plurality of network devices 122-134 which are controlled by a plurality of entities 112-118. The network devices 122-134 are connected to each other by a data network 180. An entity owns a piece of information, (i.e., user data). The owner of the user data protects it from other entities by granting other entities limited rights to exploit the user data, (i.e., by specifying rights information). It is irrelevant whether an entity that owns the user data has access to a device storing, processing, or transmitting the user data, as the ownership is a legal issue and not a technical one.

Each entity 112-118 controls one or several network devices and each network device handles one or several user data nodes. The network devices may have either wireless or wired interfaces to communicate via the data network 180. The data network 180 may be deployed under any type of wireless or wired standards. Each user data node stores a copy of an elementary piece of user data and rights information. The copy may be the original copy or a duplicate copy.

The elementary piece of user data may be any piece of information. It may be a whole document or a smaller piece of the whole document. The elementary piece of user data has a useful meaning per se and may, therefore, be exchanged across the data network 180 or dynamically updated. An example of the elementary piece of user data is user identity (ID) in medical insurance information provided by a patient to a hospital. The level of granularity of the user data is determined by the owner of the user data.

Each elementary piece of user data has a unique identifier and is associated with a unique user data traceability graph. The user data traceability graph comprises at least one traceability link which connects two user data nodes. A traceability link between two user data nodes is directional from a source user data node to a destination user data node.

Each user data traceability graph corresponds to a different elementary piece of user data. In FIG. 1, three different user data traceability graphs 172, 174, 176 are illustrated. The traceability graph 172 includes traceability links 172a-172c. The traceability graph 174 includes traceability links 174a-174e. The traceability graph 176 includes traceability links 176a-176d. The entity 112 manages two network devices 122, 124. The network device 122 handles a user data node 142 containing an elementary piece of user data belonging to the first user data traceability graph 172. The network device 124 handles a user data node 144 containing an elementary piece of user data belonging to the first user data traceability graph 172, and handles a user data node 146 containing another elementary piece of user data belonging to the second user data traceability graph 174.

The entity 114 manages a network device 126, which handles three user data nodes 148, 150, 152, which contain three elementary pieces of user data. Two elementary pieces of the user data belong to the second user data traceability graph 174, and one elementary piece of the user data belongs to the third user data traceability graph 176.

The entity 116 manages three network devices 128, 130, 132. The network device 128 handles user data nodes 156, 158 containing two elementary pieces of user data belonging to the first user data traceability graph 172. The network device 130 handles a user data node 158 containing an elementary piece of user data belonging to the third user data traceability graph 176, and handles a user data node 160 containing an elementary piece of user data belonging to the second user data traceability graph 174. The network device 132 handles a user data node 162 containing an elementary piece of user data belonging to the third user data traceability graph 176.

The entity 118 manages a network device 134, which handles three user data nodes 164, 166, 168 which contain three elementary pieces of user data. Two elementary pieces of the user data belong to the second user data traceability graph 174 and one elementary piece of the user data belongs to the third user data traceability graph 176.

Since each traceability graph is associated with a unique piece of user data, the semantic of the traceability link is the synchronization of two identical copies of this piece of user data from the source user data node to the destination user data node of the traceability link. The value stored in the destination user data node may not be identical to the value stored in the source user data node, but instead may be any general function of it. The function is associated with the traceability link and may be parameterized by factors external to the piece of user data. For instance, when the piece of user data is an amount of money and the source and destination user data nodes use different currencies, a converting function may be parameterized by the exchange rate, considered independent of the amount itself. Another example is representation of the piece of user data using different standards or formats.

The rights information comprises a rule-based policy describing the rights associated with propagation of an elementary piece of user data, propagation of the rights, notification rules, update of the original copy of the elementary piece of user data, or the like. Each elementary piece of user data has an owner who defines its associated rights vis-a-vis other entities. The owner of an elementary piece of user data has control over the rights information contained in any user data node of the associated user data traceability graph.

Entities are required to comply with the rules defined in the rights information by the owner of the user data. Such rules include, but are not limited to:

1) The owner may grant a right to an entity handling a root user data node to update the user data;

2) The owner may grant a right to an entity to distribute the user data recursively or non-recursively;

3) The owner may grant a right to an entity to distribute the rights;

4) The owner may grant a right to an entity to distribute recursive rights;

5) The owner may grant a right to an entity to alter the topology of the user data traceability graph;

6) The owner may request from the other entities to be notified when its user data is duplicated in other entities or processed, (e.g., updated at the root user data node);

7) Rights information may include rules to resolve user data propagation conflicts. Conflicts may arise when a destination user data node receives contradictory information from two different source user data nodes. The conflict may be resolved by accepting the user data having the most current time-stamp. In addition, this rule may further request the destination user data node to notify the source user data node that sent the outdated user data of such conflict and selection. This rule may even further request the destination user data node to communicate the identity of the source user data node that has more current user data of such conflict;

8) Rights information may include rules to resolve rights propagation conflicts, since rights information may be propagated to a user data node from multiple independent source user data nodes. For example, a rule may specify that the most restrictive rights information should, (e.g., non recursive rights versus recursive rights), always be followed; and

9) Another set of rules may be defined to prioritize rules.

Each user data node provides an abstract interface to other user data nodes to allow them to communicate via the abstract interface. The functions performed via the abstract interfaces of the user data nodes include, but are not limited to:

1) Functions handling the propagation of the user data recursively and non-recursively;

2) Functions handling the propagation of the rights information recursively and non-recursively;

3) Functions handling the notification of the owner of the user data of any processing or communication to other entities of the user data;

4) Functions handling the authoring of the user data and associated rights information; and

5) Functions handling the authoring of the topology of the user data traceability graph.

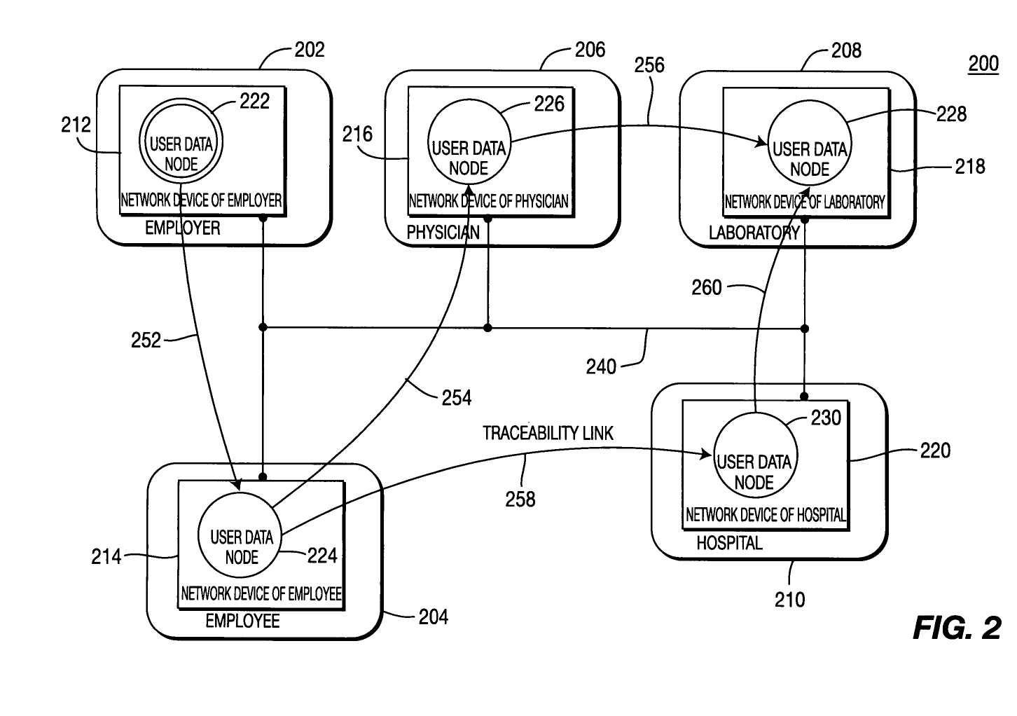

FIG. 2 shows a specific example of a system 200 which supports user data traceability in accordance with one embodiment of the present invention. It should be noted that propagation of healthcare information is provided as an example in FIG. 2, but the present invention is applicable to any type of user data. A plurality of entities 202-210 are involved in the system 200, including an employer 202, an employee 204, a physician 206, a laboratory 208 and a hospital 210. Each entity 202-210 controls a network device 212-220, respectively. Each network device 212-220 handles a user data node 222-230, respectively. The network devices 212-220 are connected via a data network 240 to each other. The data network 240 may be the Internet or any other type of communication network, either wireless or wired.

The employee 204 is hired by the employer 202 which has a contract with a healthcare insurance company to offer healthcare benefits to its employees. The employee 204 is enrolled in the healthcare plan and received healthcare insurance information from the employer. Two months later the employee 204 falls sick and makes an appointment with the physician 206. The physician's assistant asks the employee 204 to manually fill in a printed form to provide particular healthcare insurance information of the employee 204, and the healthcare insurance information is stored in a network device 216 in the physician's medical office. The physician 206 sends a blood sample to the laboratory 208 for blood test. The assistant communicates the employee's healthcare insurance information to the laboratory 208 over the phone.

After a week, the employee 204 is feeling better. However, three months later, the employee 204 faints at work, and is admitted to the hospital 210. The employee 204 is asked again to fill in a form to provide healthcare insurance information of the employee 204. The hospital 210 sends a new blood sample to the same laboratory 208, along with the employee's healthcare insurance information. While both the physician 206 and the hospital 210 are sharing identical personal information to the laboratory 208, it is possible that the two may not accurately agree.

There is one copy of the user data, (e.g., healthcare member ID), per entity 202-210. The employer's network device 212 handles a user data node 222, (i.e., root user data node), that stores the original copy, while the network devices 214-220 of the employee 204, the physician 206, the laboratory 208 and the hospital 210 each handle a user data node 224-230 that stores a duplicate copy of the healthcare member ID of the employee 204.

In addition to copies of the user data, the user data nodes 222-230 also contain copies of a rule-based policy, (i.e., rights information), expressing the rights on the user data at each user data node 222-230. For example, the employee 204 gives the employer 202 a right to update his insurance information. When the user data is distributed from the employee 204 to the physician 206 and the hospital 210, the employee 204 gives non-recursive rights to the physician 206 and the hospital 210 to propagate the user data, (i.e., the user data may be communicated to the laboratory 208 but the laboratory 208 does not inherit the rights to distribute the user data to other entities). Optionally, the entities which have distributed the user data, (e.g., the physician 206 and the hospital 210), may have to notify the owner of the user data, (i.e., the employee 204), each time the user data is distributed to other entities.

In accordance with the present invention, a user data traceability graph is generated and updated as the user data is propagated. The user data traceability graph includes a plurality of traceability links 252-260. A traceability link 252 between the root user data node 222 and the user data node 224 is added to the traceability graph when the user data is transferred from the employer 202 to the employee 204. This traceability link 252 is used to propagate copies of the user data and/or rights information whenever the user data and/or the rights information are changed in the future. Rights information that describes the policy of this propagation is attached to the traceability link 252. A second traceability link 254 between the user data node 224 and the user data node 226 is added to the traceability graph when the user data is transferred from the employee 204 to the physician 206. Rights information is also attached to the second traceability link 254. Similarly, a third traceability link 256 between the user data node 226 and the user data node 228 is added to the traceability graph when the user data is transferred from the physician 206 to the laboratory 208, and rights information is attached to the third traceability link 256. A fourth traceability link 258 between the user data node 224 and the user data node 230 is added to the traceability graph when the user data is transferred from the employee 204 to the hospital 210, and rights information is attached to the fourth traceability link 258. Similarly, a fifth traceability link 260 between the user data node 230 and the user data node 228 is added to the traceability graph when the user data is transferred from the hospital 210 to the laboratory 208, and rights information is attached to the fifth traceability link 260. When the user data at the root user data node 222 is updated, the copies in the user data nodes 224-230 of the other entities 204-210 are sequentially updated based on the traceability graph.

Rules resolving possible conflicts are defined as well. For example, when the laboratory 208 receives two different versions of the same piece of user data from the physician 206 and the hospital 210, the laboratory 208 follows the rule defined by the owner of the user data. For example, the rule may stipulate to select the piece of user data with the most up-to-date timestamp. Alternatively, the rule may stipulate to notify the owner of the user data when a conflict is detected.

The traceability link may be generated from multiple source user data nodes to one destination user data node. In this case, the traceability link is no longer a binary link, but an n-to-1 link. Each of the n source user data nodes contribute to the update of the destination user data node. An example is propagation of rights information when multiple entities need to make joint decisions on the rights to be granted to other entities.

The user data may have multiple owners. In such case, the entities may define the rights associated with the user data, either jointly or individually and appropriate rules are defined to resolve rights propagation conflicts.

The traceability graph may be generated with multiple root user data nodes. For example, an owner of user data may authorize multiple entities to update the information. In this case, appropriate rules are defined to resolve user data and rights information propagation conflicts.

When the contents of a piece of user data is frequently updated, or when the average length of the traceability paths of the traceability graph is long, the complete propagation of an update throughout the entire traceability graph may take longer than required by the application. In such situations, it may be desirable to modify the topology of the traceability graph to minimize the longest traceability path in the traceability graph without impacting the propagations rules, both for user data and for rights information. This may be accomplished by connecting each destination user data node to a unique root user data node and keeping additional topological information at each traceability link.

By way of example, assume a network includes Nodes A, B and C, and Node A propagates information to Node B, which propagates it to Node C. Instead of propagating a copy of the piece of user data to Node C, Node B may dynamically create a new traceability link from Node A to Node C, and attach the required user data and rights information to the new link (Node B will keep managing the rights information attached to this new link). The entity having legal control over Node B needs to be granted appropriate rights to alter the topology of the user data traceability graph. The advantages of this new topology are to retain the scalability of rights management through recursive propagation, while limiting the lengths of the propagation paths.

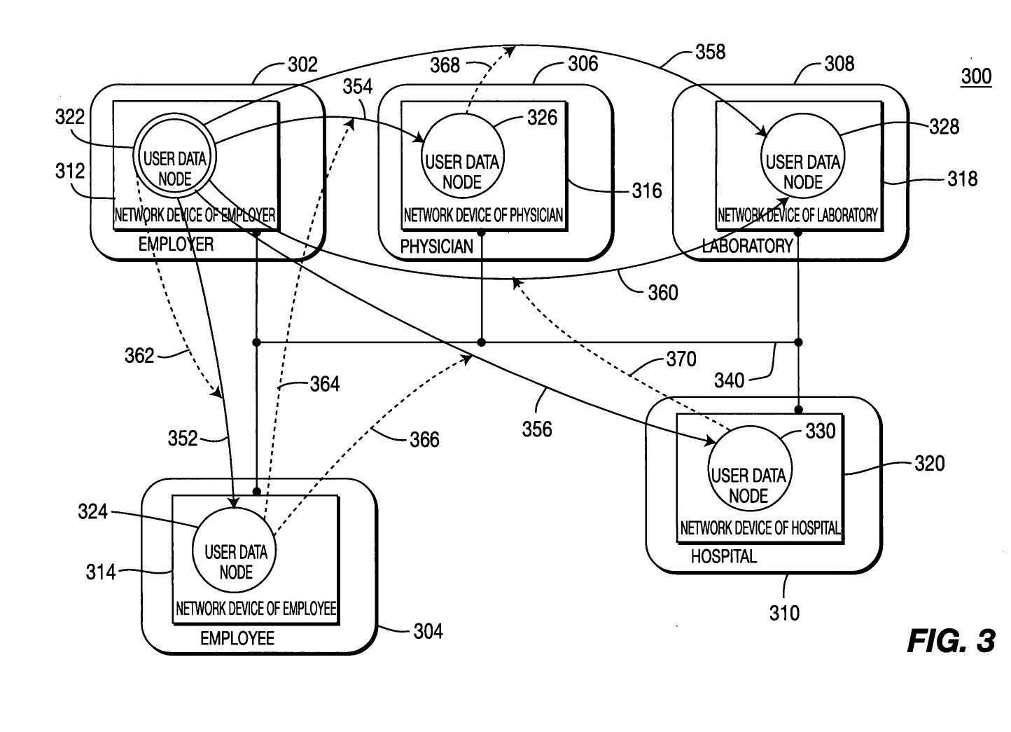

FIG. 3 shows a specific example of a system 300 which supports user data traceability in accordance with another embodiment of the present invention. Initially, a user data traceability graph has not been created yet. A plurality of entities 302-310 are involved in the system 300, including an employer 302, an employee 304, a physician 306, a laboratory 308 and a hospital 310.

A user data node 322, (which is a root user data node), handled by a network device 312 of the employer 302 is created. Then, a traceability link 352 between the root user data node 322 and a user data node 324 handled by a network device 314 of the employee 304, (who actually owns the user data) is generated and added to a traceability graph. This traceability link 352 is used to propagate copies of the user data whenever it undergoes a change in the future. The rights information that describes the policy of this propagation is attached to the traceability link 352 itself and the employer 302 retains the possibility to modify the rights information by keeping a traceability link reference 362 to the traceability link 352 to which the rights information is attached. A traceability link reference designates the reference kept by an entity on a certain traceability link. The traceability link reference allows the entity to update the rights information attached to the traceability link.

A second traceability link 354 between the root user data node 322 and a user data node 326 handled by a network device 316 of the physician 306 is added to the traceability graph. The rights information is attached to the traceability link 354 and the employee 304 keeps a traceability link reference 364 to the traceability link 354. Similarly, a third traceability link 356 between the root user data node 322 and a user data node 330 handled by a network device 320 of the hospital 310 is added to the traceability graph. The rights information is attached to the traceability link 356 and the employee 304 keeps a traceability link reference 366 to the traceability link 356. Then, a fourth traceability link 358 between the root user data node 322 and a user data node 328 handled by a network device 318 of the laboratory 308 is added to the traceability graph. The rights information is attached to the traceability link 358 and the physician 306 keeps a traceability link reference 368 to the traceability link 358. Similarly, a fifth traceability link 360 between the root user data node 322 and a user data node 328 handled by a network device 318 of the laboratory 308 is added to the traceability graph. Rights information is attached to the traceability link 360, and the hospital 310 keeps a traceability link reference 370 to this traceability link 360.

After constructing the traceability graph, when the copy of user data at the root user data node 322 is updated, the copies in the user data nodes 324-330 of the other entities 304-310 are simultaneously updated since they are directly connected to the root user data node 322. Therefore, the propagation of the user data is more efficient.

When the owner of the user data, (the employee 304), wants to grant more rights to the physician 306, the employee 304 updates the rights information attached to the traceability link 354 between the root user data node 322 and the user data node 326. Then, the physician 306 updates the rights information attached to the traceability link 358 between the root user data node 322 and the user data node 328.

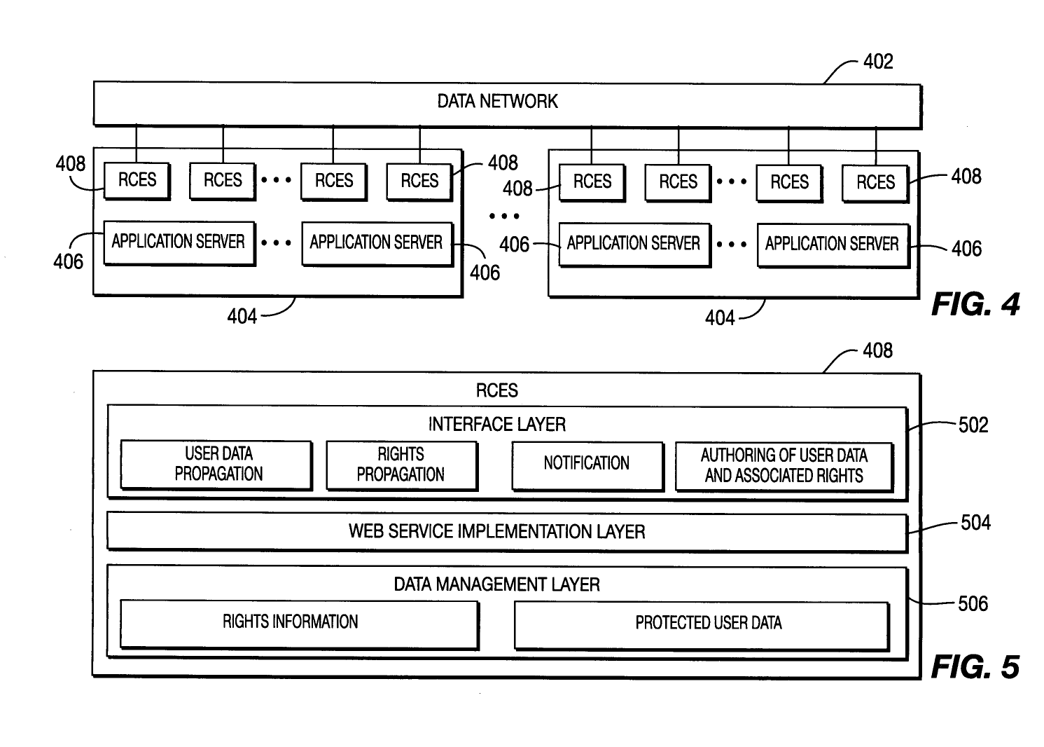

FIG. 4 is a block diagram of a system 400 implemented by service oriented architecture (SOA) in accordance with the present invention. Implementation of the present invention requires several technical requirements, such as atomicity, data and process persistency, platform independency, reliability, acceptance and cost effectiveness. The present invention may be implemented by SOA technologies since the above requirements may be satisfied with the SOA technologies.

The system 400 includes a data network 402 and a plurality of network devices 404 controlled by a plurality of entities. The network devices 404 are connected to the data network 402. Each network device 404 comprises a first processor 406 for running one or more application servers and a second processor 408 for running one or more rights and consistency enforcement services (RCESs). Alternatively, the application server and the RCESs may run on the same processor. The application servers listen to incoming requests and instantiate a RCES accordingly. Each RCES is associated with a user data node.

Each entity offers access to an elementary piece of user data through an agreed upon web services interface. The implementation of these services for each entity depends on the data persistency technology. For example, software of the employer may be built on a relational database, while the physician software may store the user data on spreadsheet documents in the foregoing example.

FIG. 5 is a block diagram of the second processor 408 in the network devices 404 in accordance with the present invention. The second processor 408 comprises an interface layer 502, a web service implementation layer 504 and a data management layer 506. The interface layer 502 includes a web service interface definition including user data propagation, rights propagation, notification and authoring of user data and associated rights. The interface layer 502 exposes to the data network the methods of the services organized according to a functional classification. The web service interface definition may take the form of web services description language (WSDL) files, entries in universal description, discovery and integration (UDDI) or other similar catalogs and network listeners part of the application server.

The web service implementation layer 504 connects the interface layer 502 to the underlying data management layer 506. The web service implementation layer 504 may take the form of executable code instantiated by the application server and run in the runtime environment defined by the application server.

The data management layer 506 provides storage and basic data managements for the rights information and the protected user data. The data management layer 506 may take the form of relational databases with various schemes or files of various formats.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A system for enforcing user rights on user data and consistency of the user data, the system comprising:
a data network; and
a plurality of network devices electrically coupled to the data network, each network device comprising at least one user data node which contains at least one elementary piece of user data, the elementary piece of user data being associated with a traceability graph comprising at least one traceability link which connects a source user data node which sends the elementary piece of user data and a destination user data node which receives the elementary piece of user data, whereby consistency of the user data is obtained based on the traceability graph.

2. The system of claim 1 wherein the user data node further contains rights information which comprises a rule-based policy regarding the user data.

3. The system of claim 2 wherein the rights information is propagated to other entities based on the traceability graph.

4. The system of claim 2 wherein the rule-based policy specifies rules regarding at least one of propagation of the elementary piece of user data, propagation of the rights, notification, and update of an original copy of the elementary piece of user data.

5. The system of claim 2 wherein the rule-based policy is specified by an owner of the user data.

6. The system of claim 5 wherein the owner grants a right to an entity handling a root user data node from which the elementary piece of user data is originated to update the user data.

7. The system of claim 5 wherein the owner grants a right to an entity to distribute the elementary piece of user data recursively.

8. The system of claim 5 wherein the owner grants a right to an entity to distribute the elementary piece of user data non-recursively.

9. The system of claim 5 wherein the owner grants a right to an entity to distribute recursive rights.

10. The system of claim 5 wherein the owner grants a right to an entity to alter a topology of the traceability graph.

11. The system of claim 5 wherein the owner requests other entities to notify the owner whenever the elementary piece of user data is duplicated to other entities.

12. The system of claim 5 wherein the owner requests other entities to notify the owner whenever the elementary piece of user data is processed.

13. The system of claim 2 wherein the rights information includes rules to resolve user data propagation conflicts.

14. The system of claim 13 wherein the conflict is resolved by accepting an elementary piece of user data having a most current time-stamp.

15. The system of claim 13 wherein the rule requests the destination user data node to notify the source user data node that sent an outdated elementary piece of user data of such conflict.

16. The system of claim 2 wherein the rights information includes rules to resolve rights propagation conflicts.

17. The system of claim 1 wherein each user data node provides an abstract interface for communication to other user data nodes.

18. The system of claim 17 wherein the abstract interface performs at least one of functions handling the propagation of the elementary piece of user data recursively and non-recursively, functions handling the propagation of the rights information recursively and non-recursively, functions handling the notification of the owner of the elementary piece of user data of any processing and distribution of the elementary piece of user data, functions handling authoring of the elementary piece of user data and associated rights information and functions handling authoring of the topology of the traceability graph.

19. The system of claim 1 wherein the traceability graph is established between a plurality of source user data nodes and one destination user data node.

20. The system of claim 1 wherein the elementary piece of user data is owned by a plurality of owners.

21. The system of claim 1 wherein the traceability graph is generated with multiple root user data nodes from which the elementary piece of user data is originated.

22. The system of claim 1 wherein the traceability graph is generated by connecting each destination user data node to a root user data node from which the elementary piece of user data is originated and each user data node maintains a traceability link reference.

23. The system of claim 1 wherein the network devices are implemented by service oriented architecture (SOA).

24. The system of claim 23 wherein each network device comprises:
a first processor for running at least one application server; and
a second processor for running at least one rights and consistency enforcement service (RCES), the RCES being associated with the user data node.

25. The system of claim 24 wherein the second processor comprises;
an interface layer for exposing methods of services to the data network;
a data management layer for providing storage and basic data managements for the rights information and the user data; and
a web service implementation layer for connecting the interface layer to the data management layer.

26. The system of claim 25 wherein the interface layer includes a web service interface definition.

27. The system of claim 26 wherein the web service interface definition includes at least one of user data propagation, rights propagation, notification and authoring of user data and associated rights.

28. The system of claim 27 wherein the web service interface definition takes a form of at least one of web services description language (WSDL) files, entries in universal description, discovery and integration (UDDI) and network listeners part of the application server.

29. The system of claim 25 the web service implementation layer takes a form of executable code instantiated by the application server and runs in a runtime environment defined by the application server.

30. The system of claim 25 wherein the data management layer takes a form of relational databases.

31. In a system including a data network which connects a plurality of network devices wherein each network device handles at least one user data node and each user data node stores at least one elementary piece of user data propagated via the data network, a method for enforcing user rights on user data and consistency of the user data, the method comprising:
generating a traceability graph which is associated to an elementary piece of user data, the traceability graph comprising at least one traceability link which connects a source user data node which sends the elementary piece of user data and a destination user data node which receives the elementary piece of user data; and
updating the elementary piece of user data when the elementary piece of user data is changed based on the traceability graph.

32. The method of claim 31 wherein the user data node further contains rights information which comprises a rule-based policy regarding the user data.

33. The method of claim 32 further comprising:
propagating the rights information to other entities based on the traceability graph.

34. The method of claim 32 wherein the rule-based policy specifies rules regarding at least one of propagation of the elementary piece of user data, propagation of the rights, notification, and update of an original copy of the elementary piece of user data.

35. The method of claim 32 wherein the rule-based policy is specified by an owner of the user data.

36. The method of claim 35 wherein the owner grants a right to an entity handling a root user data node from which the elementary piece of user data is originated to update the user data.

37. The method of claim 35 wherein the owner grants a right to an entity to distribute the elementary piece of user data recursively.

38. The method of claim 35 wherein the owner grants a right to an entity to distribute the elementary piece of user data non-recursively.

39. The method of claim 35 wherein the owner grants a right to an entity to distribute recursive rights.

40. The method of claim 35 wherein the owner grants a right to an entity to alter a topology of the traceability graph.

41. The method of claim 35 wherein the owner requests other entities to notify the owner whenever the elementary piece of user data is duplicated to other entities.

42. The method of claim 35 wherein the owner requests other entities to notify the owner whenever the elementary piece of user data is processed.

43. The method of claim 32 wherein the rights information includes rules to resolve user data propagation conflicts.

44. The method of claim 43 wherein the conflict is resolved by accepting an elementary piece of user data having a most current time-stamp.

45. The method of claim 43 wherein the rule requests the destination user data node to notify the source user data node that sent an outdated elementary piece of user data of such conflict.

46. The method of claim 32 wherein the rights information includes rules to resolve rights propagation conflicts.

47. The method of claim 31 wherein the traceability graph is established between a plurality of source user data nodes and one destination user data node.

48. The method of claim 31 wherein the elementary piece of user data is owned by a plurality of owners.

49. The method of claim 31 wherein the traceability graph is generated with multiple root user data nodes from which the elementary piece of user data is originated.

50. The method of claim 31 wherein the traceability graph is generated by connecting each destination user data node to a root user data node from which the elementary piece of user data is originated.

51. The method of claim 50 further comprising:
generating a traceability link reference for each traceability link at each user data node, whereby each user data node updates rights information based on the traceability link reference.
